(19) United States
(12) Patent Application Publication
(10) Pub. No.: US 2013/0290083 A1
(43) Pub. Date: Oct. 31, 2013

(54) SYSTEM AND METHODS FOR PROVIDING ONLINE AUCTIONS WITH SWEEPSTAKES ENTRIES

(71) Applicant: PENTECH SOLUTIONS, INC., Acworth, GA (US)

(72) Inventor: Michael D. Randel, Acworth, GA (US)

(73) Assignee: Pentech Solutions, Inc., Acworth, GA (US)

(21) Appl. No.: 13/871,850

(22) Filed: Apr. 26, 2013

Related U.S. Application Data
(60) Provisional application No. 61/639,666, filed on Apr. 27, 2012.

(51) Int. Cl. G06Q 30/08

(52) U.S. Cl. CPC G06Q 30/08; G06Q 30/0212
USPC 705/14.14

(57) ABSTRACT

A method of conducting an auction is described herein. The method includes receiving a first bid unit purchase request from a user and responsively generating at least one initial bid unit for bidding on one or more auction items displayed in the auction. The method also includes distributing at least one sweepstakes entry into a sweepstakes event to the user in response to the received purchase request, providing a sweepstakes award to the user as a function of the at least one sweepstakes entry, and allowing the user to purchase at least one addition bid unit with at least a portion of the sweepstakes award.

### CROSS-REFERENCE TO RELATED APPLICATIONS

This application claims the benefit of U.S. Provisional Application No. 61/639,666, filed Apr. 27, 2012, the disclosure of which is incorporated herein by reference.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The subject matter disclosed herein relates generally to placing bids on auction items and more particularly, to systems and methods for providing online auctions with sweepstakes entries and revealing sweepstake results according to a user selected preference, wherein the available preference for selection may include revealing the results instantly or revealing the results through entertaining amusement displays of one or more simulated games or casino game style graphics.

### BACKGROUND OF THE INVENTION

Online auctions have become a popular activity for users interested in purchasing goods and services online. Many online auctions allow a person to bid on an item in an attempt to obtain a winning bid and an associated opportunity to purchase the auction item at the winning bid price. Known online auction websites allow several users to compete with other online auction participants by submitting bids on a particular item until a predefined period of time has elapsed, and the highest bidder is determined.

At least some known online auction websites require users to purchase a bid unit that represents an opportunity to submit a bid in an auction and to redeem a bid unit each time the user places a bid on an auction item. Once the user has redeemed all of the bid units, the user cannot participate in the auction until additional bid units are purchased. By requiring a user to purchase bid units to participate in the auction, the online auction receives revenue from each user participating in the auction.

Many auction participants are attracted to the challenge offered by new auction items and may become frustrated with a requirement to purchase new bid units each time a user wishes to place a bid on an auction item. Auction participants may also become frustrated by purchasing bid units, participating in the auction, and not winning an auction. Likewise, online auction providers desire new auctioning opportunities to appeal to their auction participants and entice users to place additional bids, spend more time in the auction website, and have additional opportunities to benefit from the auction without additional participant cost. Accordingly, there is a continued need for systems and methods that create, provide and facilitate new and interesting online auctions.

### SUMMARY OF THE INVENTION

The invention is generally directed to systems and methods for providing an auction platform with associated sweepstakes entry and result revealing features.

In one aspect of the invention, a method of conducting an auction is provided. The method includes receiving a first bid unit purchase request from a user and responsively generating at least one initial bid unit for bidding on one or more auction items displayed in the auction. The method also includes distributing at least one sweepstakes entry into a sweepstakes event to the user in response to the received purchase request, providing a sweepstakes award to the user as a function of the at least one sweepstakes entry, and allowing the user to purchase at least one addition bid unit with at least a portion of the sweepstakes award.

In another aspect of the invention, a system for allowing a user to participate in an auction via a user computing device is provided. The system includes a plurality of user computing devices and a system controller that is coupled to each user computing device. Each user computing device includes a user input device for accepting a user's selection input and a display device. The system controller receives a request to display information associated with the auction, retrieves a plurality of auction items included in the auction, and displays the plurality of auction items on the corresponding user computing device. The system controller also receives a first bid unit purchase request from a user and responsively generates at least one initial bid unit for bidding on one or more auction items displayed in the auction. The system controller also distributes at least one sweepstakes entry into a sweepstakes event to the user in response to the received purchase request, provides a sweepstakes award to the user as a function of the at least one sweepstakes entry, and allows the user to purchase at least one addition bid unit with at least a portion of the sweepstakes award. The system controller may also distribute at least one sweepstakes entry into a sweepstakes event to the user in response to the received alternative method of entry, and in response to the purchase of an actual product or service by the user, as may be required by law.

In yet another aspect of the invention, one or more non-transitory computer-readable storage media, having computer-executable instructions embodied thereon is provided. The computer-executable instructions, when executed by at least one processor, cause the processor to receive a request from a user to display information associated with an auction, retrieve an auction list including a plurality of auction items, and display the plurality of auction items on a user computing device. The computer-executable instructions also cause the processor to receive a first bid unit purchase request from the user and responsively generate at least one initial bid unit for bidding on one or more auction items displayed in the auction. The computer-executable instructions also cause the processor to distribute at least one sweepstakes entry into a sweepstakes event to the user in response to the received purchase request, provide a sweepstakes award to the user as a function of the at least one sweepstakes entry, and allow the user to purchase at least one addition bid unit with at least a portion of the sweepstakes award.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system, according to an embodiment of the invention;

FIG. 2 is a flowchart of a method that may be used with the system shown in FIG. 1 for allowing a user to participate in a auction via a user computing device, according to an embodiment of the invention;

FIG. 3 is a graphical display of an online auction that may be used with the method shown in FIG. 2, according to an embodiment of the present invention;

FIG. 4 is a graphic display of a sweepstake award selection screen, according to an embodiment of the invention;

FIG. 5 is an exemplary entertaining graphical display of a simulated casino-type game selection screen, according to an embodiment of the present invention;

FIG. 6 is an exemplary entertaining graphical display for amusement purposes of a simulated video blackjack game that may be used with the method shown in FIG. 2, according to an embodiment of the present invention;

FIG. 7 is an exemplary entertaining graphical display for amusement purposes of a simulated video slot game that may be used with the method shown in FIG. 2, according to an embodiment of the present invention; and,

FIG. 8 is an exemplary entertaining graphical display for amusement purposes of an instant reveal simulated game that may be used with the method shown in FIG. 2, according to an embodiment of the present invention.

Corresponding reference characters indicate corresponding parts throughout the drawings.

### DETAILED DESCRIPTION OF THE PREFERRED EMBODIMENT

With reference to the drawings and in operation, the invention overcomes at least some of the disadvantages of known auction systems by providing, among other things, systems and methods which enable a user to purchase one or more bid packets for use in an auction, provide the user with entries into a sweepstakes based on an amount of purchased bid packets, alternative method of entry, or product purchase, and enable the user to reveal the results of the sweepstakes entries via one or more simulated casino-type games. For example, the system and methods of the invention are configured to display a listing including a plurality of auction items available for bid, receive a bid unit purchase request from a user and responsively generating at least one initial bid unit for bidding on one or more auction items displayed in the auction, distribute at least one sweepstakes entry into a sweepstakes event to the user in response to the received purchase request, provide a sweepstakes award to the user as a function of the at least one sweepstakes entry, and, allow the user to purchase at least one addition bid unit with at least a portion of the sweepstakes award. By providing a plurality of sweepstakes entries to the user based on the purchase of bid packets for use in an auction and allowing the user to use the sweepstakes award to purchase additional bid packets, the amount of time a user spends bidding on auction items is increased, thus increasing the amount of bids received for the auction items and increasing the amount of revenue received from the auction. It should be understood that systems and methods of the invention may be configured to enable sweepstakes winnings to be applied to purchase products or services, redeem as cash or something else of value or donate to a charitable cause.

The invention is generally directed to systems and methods for promoting and facilitating the sale of goods and/or services through the provision and play of sweepstakes type game wherein one or more entries to the sweepstakes type game are configured to be distributed without extra cost to buyers of the sale of the goods and/or services.

In some embodiments, the systems and methods involve one or more computing terminals, which may be thin client type terminals, personal computers, mobile devices or any other associated computing platform, all of which are connected to a central controller through a distributed or global computing network.

In some embodiments, the systems and methods involve the provision of a user interface on the associated platforms which enables a user to purchase a good and/or service through the transmission of necessary information to complete the purchase, receive confirmation of the purchase and receive a sweepstakes entry which may be in the form of a confirmation number, bar code, virtual point, or a virtual or physical ticket. The systems and methods of the invention are therefore configured to receive and process the purchase, and communicate to the user interface the confirmation of the purchase as well as facilitate the transmission and delivery of the sweepstakes entry. The system and methods of the invention may further provide the ability for users to obtain a sweepstakes entry by purchasing products, or by means of an alternative method of entry without purchasing goods or services, as may be necessary according to applicable laws.

In some embodiments, the outcome of the sweepstakes entry (that is, whether the entry indicates the entrant has won or lost) may be revealed via the user interface, whereas in other embodiments the outcome may only be revealed using a different platform. The user may be provided with an option to reveal the outcome of the sweepstakes entry immediately or through simulated gaming activity. The simulated gaming activity may be a game of chance, such as poker or slots game, which may allow for player interactions and appear to be randomly operating, but which has an outcome that is predetermined and corresponds with the sweepstakes entry outcome.

In some embodiments, the goods for sale include a voucher, which may be electronic or in a physical form with a computer readable feature, allowing a user to bid for items offered in an auction available through the user interface. Each bid voucher may have a set unit value for purchase by a user and a set unit value for bidding at an auction, which may differ from each other. When the bid voucher is submitted or transmitted for placing a bid at an auction the bidding value would then be incremented to the current bid according to the set unit value.

In an exemplary embodiment, the invention is directed to a system and method which includes hardware and software for providing a central server based electronic sweepstakes application as a promotional tool to an on-line “penny auction” web site which is also server based. The on-line penny auction is a web-based auction for consumer goods where multiple computer users compete to purchase a product by placing on-line bids. The bids may typically increase by 1 cent per bid. Packages of individual bidding units may be sold in bid packages for any predetermined amount of money, such as for example, an amount of money between 60 cents and 1 dollar per bid. In this embodiment, bid units are electronic options to enter a bid on a product or service offered at auction.

For example, in one embodiment, each bid unit may be purchase of $1. If a product auction is started at 1 cent, and if each bid increases the price by 1 cent, and the ending auction price is $100.01, then a total of 10,000 bids units were entered—which is $10,000 worth of bids. The auction company would make that $10,000 plus the $100 which is paid for the product, minus the cost of the product. In some embodiments, participants in the auction can opt to purchase the product at full price.

In this embodiment, each purchase of a single bid unit would also entitle the purchaser to a single sweepstakes entry. The sweepstakes in this example uses a finite pool math model to award cash prizes to sweepstakes entrants who have winning entries. The visual simulation may be a presentation which appears like video poker or video slots. The amount in the sweepstakes won, if any, is predetermined from a finite pool. The video presentation which resembles a gambling style game is therefore merely an entertaining way, for amusement purposes, of revealing the outcome of the entries. The sweepstakes is a method of promoting the auction business of the example, among other things.

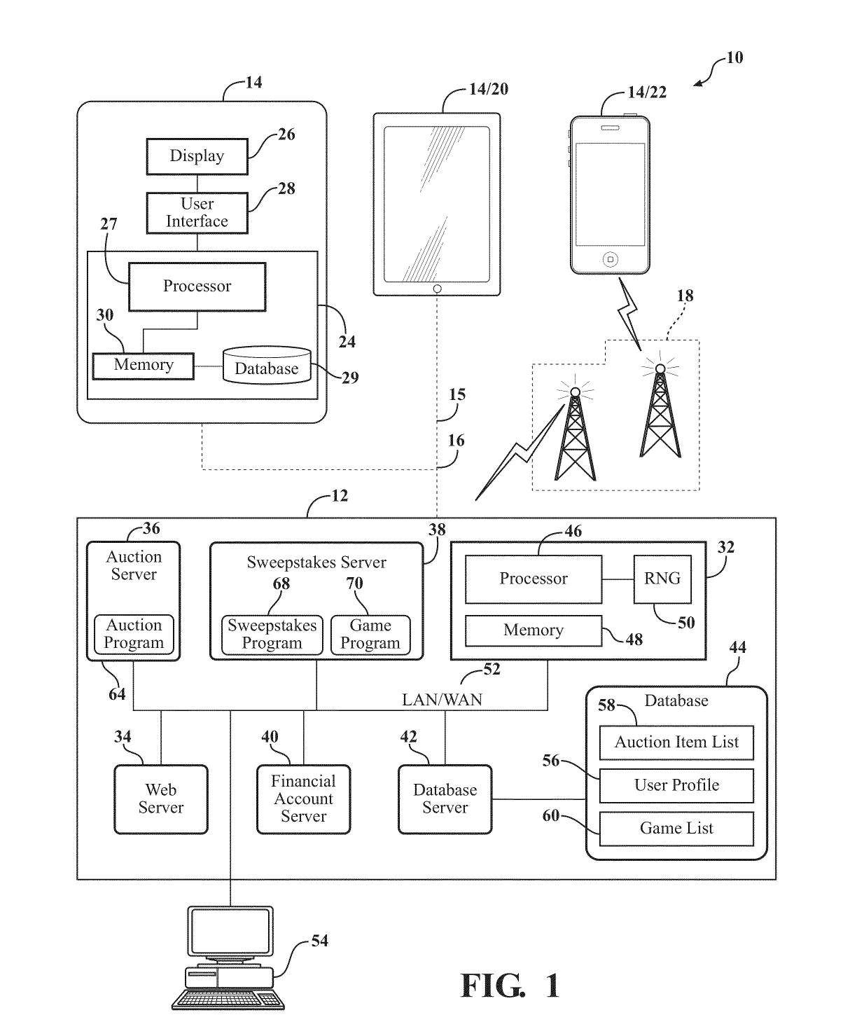

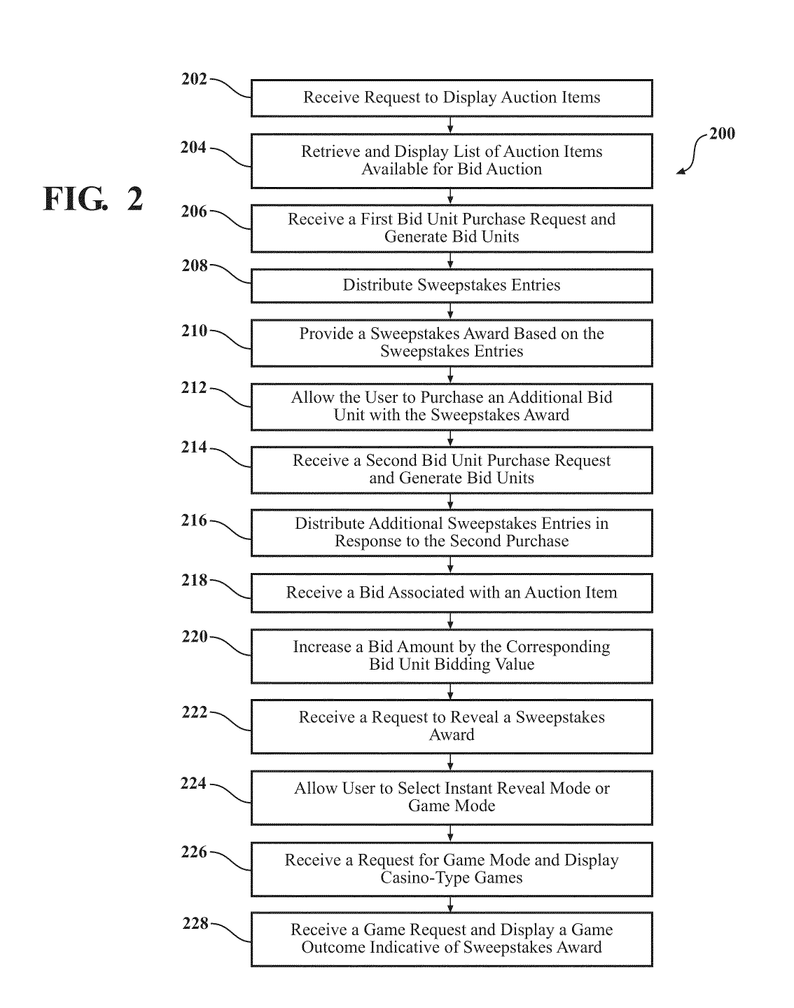

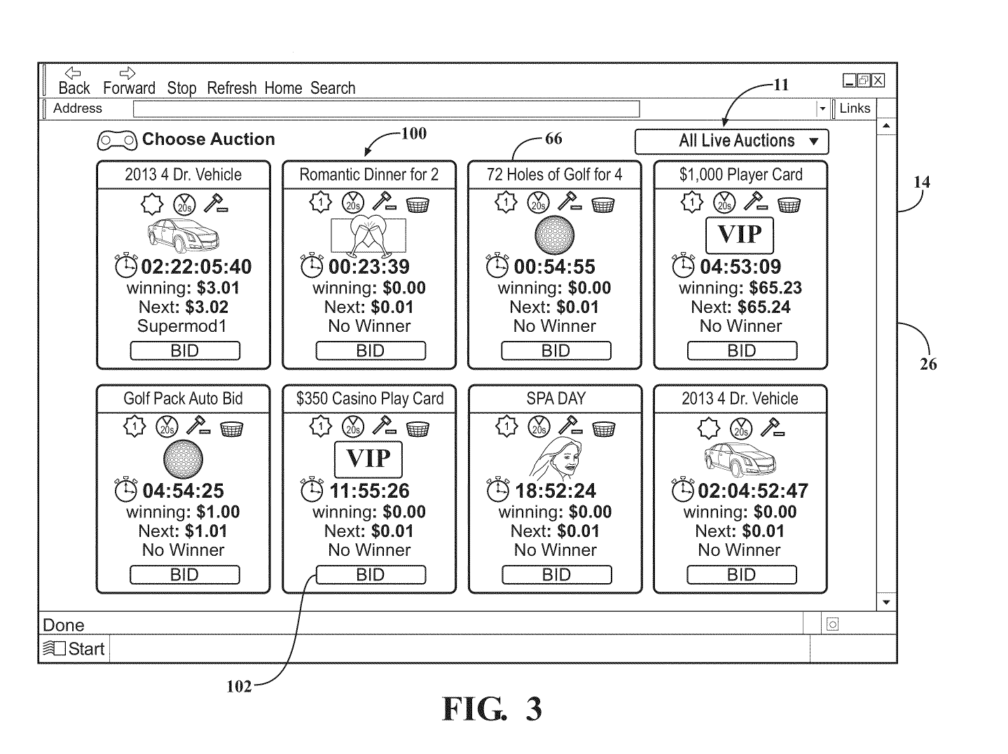

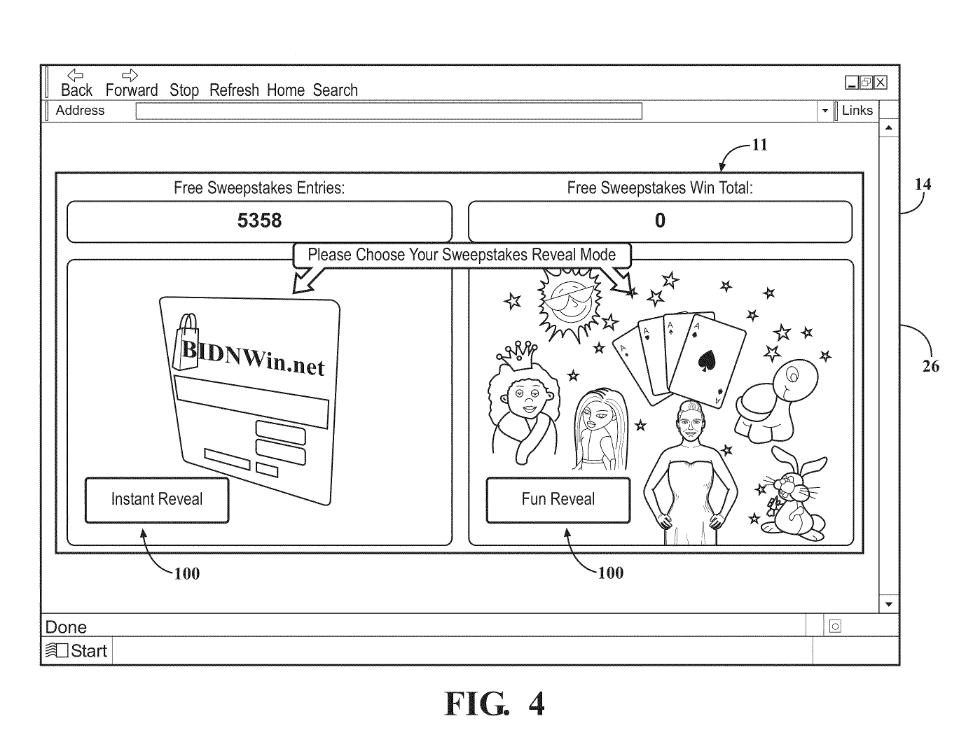

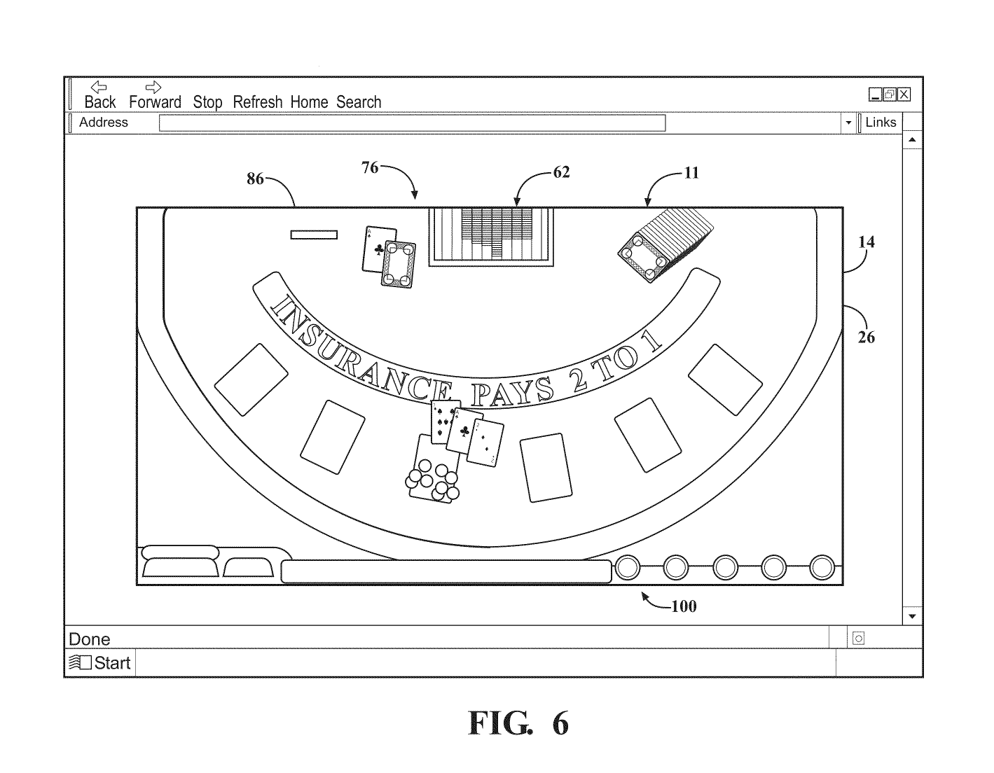

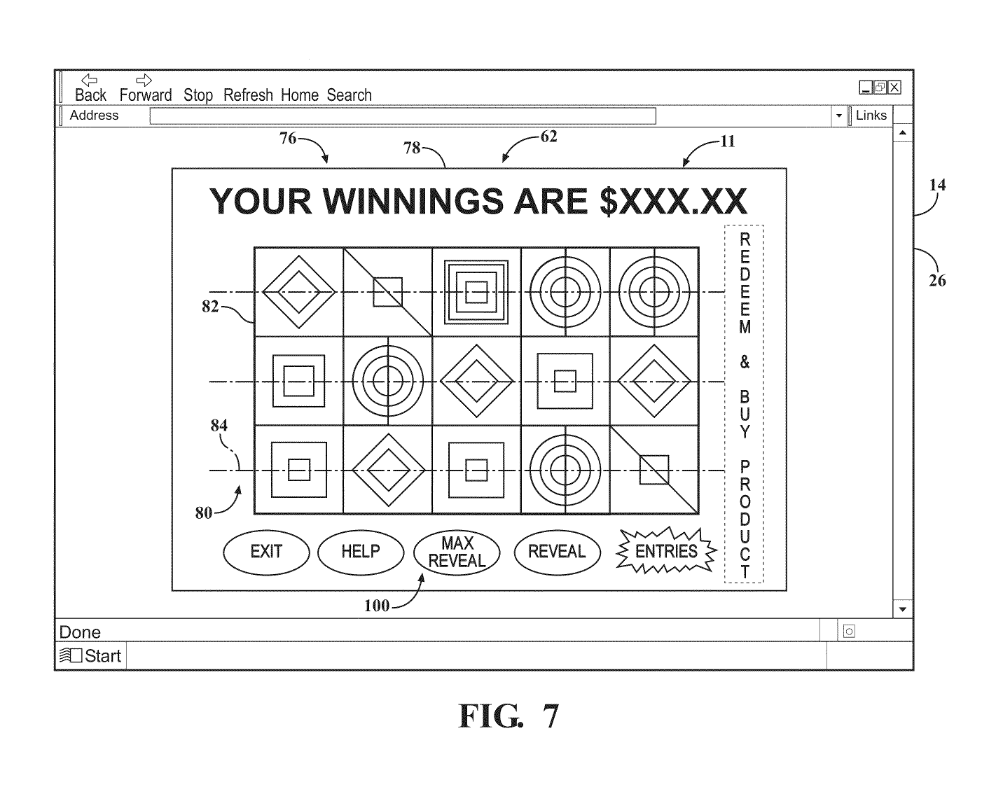

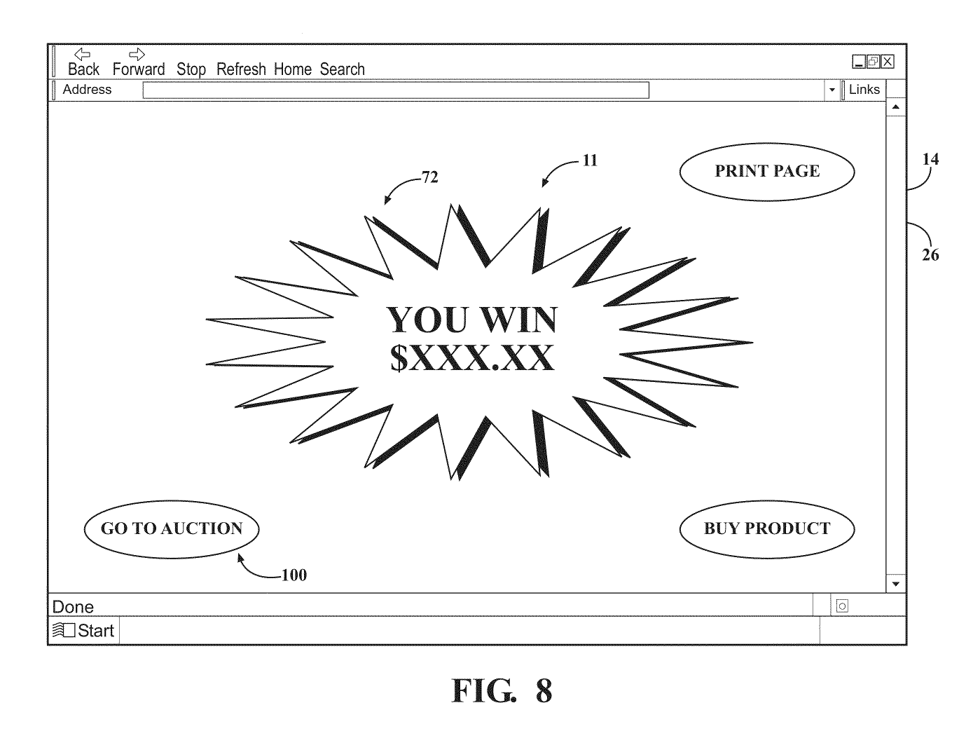

In an embodiment shown in FIGS. 1-8, a sweepstakes is combined with an on-line auction web site to form a system and method of the invention. In one example, when a purchase of a “bid package” is made, the customer is automatically awarded with “free” sweepstakes entries, which may include 100 entries per dollar spent. The entries and winnings are stored in their on-line account maintained in memory. At any time, the customer can click on a “reveal entries” button which will open a new browser window and the sweepstakes game web application. The user will have an instant reveal option, or a multitude of simulated games which they could use to reveal their results. The simulated games can be based on any game, and may be simulated casino or non-casino style games, wherein the outcome is predetermined and the simulation is for entertainment and/or amusement purposes. When a customer wins, they can convert their winnings into cash credits which are usable to purchase products on the auction site, purchase bid units, redeem for case or something of value or donate to charity. FIG. 2 provides a flow chart to illustrate the features and functionality of the method of this embodiment, which include the ability to create an account, purchase and receive bid options, receive sweepstakes entry, engage in an online auction, and determine the outcome of the sweepstakes entry, among other things. As shown in FIG. 4, users may opt to select “Instant Reveal” or some other selectable option to cause the system to determine and/or reveal the outcome of the sweepstakes immediately, which may be provided through a screen such as the screen shown in FIG. 8. Alternatively, as shown in FIGS. 3-7, users may select a simulated game for entertaining amusement purposes to reveal the outcome of the sweepstakes entry. In this embodiment, there are a plurality of casino-type games (shown in FIGS. 3-7) that are available to the user. As discussed herein, the games are simulated in that they may involve player interaction or appear to involve player decision making and appear to provide randomly generated results, but the result is the same predetermined outcome of the sweepstakes entry that would be communicated if “Instant Reveal” now had been selected. FIG. 7 illustrates an exemplary screen in which the simulated game selected resembles a slot machine with multiple reels, including providing the user with the option to apply multiple sweepstakes entries. For example, if multiple sweepstakes entries are revealed using this simulation, the reels would stop yielding an outcome and award equal to the cumulative award of the sweepstakes entries. FIG. 6 illustrates an exemplary screen in which the simulated game selected resembles a blackjack-type game.

In some embodiments, the winnings or awards may be converted into a variety of forms, physical or electronic, such as cash, products, services, credits which may be applied towards purchases of items at auction or for items offered by retailers on the same site or other sites, credits towards the play of a wagering game, or additional bid options or packages, among other things.

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

FIG. 1 is a schematic representation of the system 10, according to an embodiment of the invention. In the illustrated embodiment, the system 10 includes a server system 12 that is coupled to one or more user computing devices 14. Each user computing device 14 is configured to transmit and receive data to and/or from the server system 12 to display graphical interfaces 11 (shown in FIGS. 3-8) to enable a user to participate in an auction via the user computing device 14. In the illustrated embodiment, the server system 12 is coupled to each user computing device 14 via a communications link 15 that enables each user computing device 14 to access server system 12 over a network 16, such as the Internet, a cellular network 18, a wireless network and/or any suitable telecommunication network that enables the user computing devices 14 to access the server system 12. For example, in one embodiment, the user computing device 14 includes a mobile computing device 20, e.g. a smartphone 22 that communicates with the server system 12 via the cellular telecommunications network 18 and/or the Internet. In another embodiment, the user computing device 14 may include a personal computer, laptop, cell phone, tablet computer, smartphone/tablet computer hybrid, personal data assistant, and/or any suitable computing device that enables a user to connect to the server system 12 and display the graphical interfaces 11.

In the illustrated embodiment, each user computing device 14 includes a controller 24 that is coupled to a display device 26 and a user input device 28. The display device 26 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 28 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the controller 24 and/or to retrieve data from the controller 24. Alternatively, a single component, such as a touch screen, a capacitive touch screen, and/or a touchless screen, may function as both the display device 26 and as the user input device 28.

In the illustrated embodiment, the controller 24 includes a processor 27, a database 29, and a memory device 30 that is coupled to the processor 27 and the database 29. The memory device 30 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 27 to store, retrieve, and/or execute instructions and/or data. The processor 27 executes various programs, and thereby controls other components of the controller 24 and the user computing device 14 according to user instructions and data accepted by the user input device 28. The processor 27 in particular displays the graphical interface 11 (shown in FIGS. 3-8), and thereby enables the system 10 to generate auction items and allow the user to place bids associated with the auction items in response to user instructions received via the user computing devices 14 in accordance with the embodiments described herein. The memory device 30 stores programs and databases used by the processor 27. Moreover, the memory device 30 stores and retrieves information in the database 29 including, but not limited to, image data for producing images and/or screens on the display device 26, and temporarily stores variables, parameters, and the like that are used by the processor 27.

In the illustrated embodiment, the server system 12 includes a system controller 32, a web server 34, an auction server 36, a sweepstakes server 38, a financial account server 40, a database server 42, and a database 44. Moreover, the system controller 32 includes a processor 46, a memory device 48, and a random number generator 50, and communicates with each user computing device 14 to enable the user to access the server system 12. The system controller 32 is connected to the servers, and the database 44 through a network 52 such as, for example, a local area network (LAN), a wide area network (WAN), dial-in-connections, cable modems, wireless modems, and/or special high-speed Integrated Services Digital Network (ISDN) lines. Moreover, at least one administrator workstation 54 is also coupled to the network 52 to enable communication with the server system 12. Alternatively, the workstation 54 may be coupled to the network 52 using an Internet link or may be coupled through an intranet.

The web server 34 communicates with the user computing devices 14 to facilitate transmitting data over the network 16 via the Internet and/or the cellular network 18, respectively.

The database server 42 is connected to the database 44 that contains information on a variety of matters, such as, for example, account information related to a user, user profile information, sweepstakes event information and/or auction event information. In one embodiment, the database 44 includes a centralized database that is stored on server system 12 and is accessed directly via the user computing devices 14. In an alternative embodiment, the database 44 is stored remotely from the server system 12 and may be non-centralized. In the illustrated embodiment, the database 44 includes a user profile program 56 that includes a plurality of user profile accounts and a plurality of corresponding unique user identifiers. For example, in one embodiment, the unique user identifier may include a combination of a username and password. Alternatively, in another embodiment, the unique user identifier may include a personal identification number, or a random identification number assigned to a corresponding user account. In the illustrated embodiment, the system 10 uses the unique user identifier to identify the user and provide access to the server system 12 via a user computing device 14 associated with the unique user identifier. For example, in one embodiment, the unique user identifier may include a mobile device identifier, such as, for example, a cellular phone number and/or wireless internet address for identifying a user computing device 14 associated with a user account.

In one embodiment, the server system 12 may communicate with a player tracking system (not shown) available at a gaming establishment, e.g. a casino. The player tracking system may include a player status associated with the user, e.g. a player ranking, based on the player account information such as, for example, a frequency in which the player plays a game at the associated casino, the average wager the player makes per play of a game, a total amount wagered by the player over a predefined period of time, and/or any other suitable player tracking information. The user profile program 56 may include data that is provided to the player tracking system to identify the user at the casino to enable the user to redeem sweepstakes awards at the casino with the associated user profile account. Moreover, a player may also receive awards from the casino for play at the casino, which may be transmitting from the player tracking system to the server system 12 for use in purchasing bid units, bid packets, auction items, store items, and/or any suitable use that enables the system 10 to function as described herein. It should be understood that server system 12 may communicate with any third party platform in addition to gaming establishments in order to advantageously transfer winnings for use therein in marketing, promotions or point-of-service transactions involving goods and services.

Each user profile account includes personal identification information such as, for example, a user name, address, personal identification number, date of birth, email address, mobile phone number, and/or any suitable information that enables the system 10 to function as described herein. In one embodiment, the user profile account may include a collection of user-defined categories that are indicative of preferred auction items. For example, in one embodiment, the user profile account may include a list of preferred auction item categories such as, for example, goods, service, travel, vehicles, sporting events, bid pricing, bid period, and/or any suitable auction event category identified by the associated user.

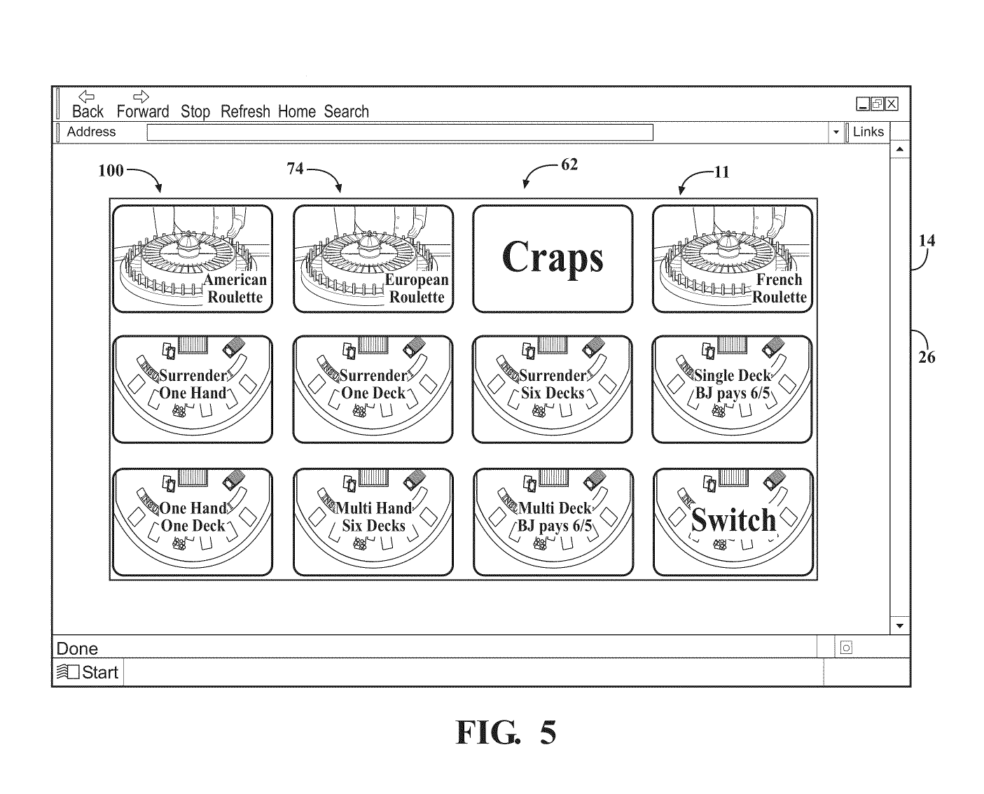

In the illustrated embodiment, the database 44 also includes an auction item list 58 and a game list 60. The auction item list 58 includes information related to a collection of auction items that are available for bid in an auction event. The game list 60 includes data related to a collection of simulated casino-type games 62 (shown in FIGS. 5-7) that are available to use in revealing a sweepstakes award to the user. The simulated casino-type games may include, but are not limited to, a video slot game, a keno game, a blackjack game, a video craps game, a video poker game, or any casino-type of game which allows a player to place a wager, play a game, and potentially provide the player an award.

In the illustrated embodiment, the auction server 36 includes an auction program 64 that includes a plurality of auction items 66 (shown in FIG. 3) that are available for display on the user computing devices 14. Moreover, the auction program 64 includes information associated with each auction item including, but not limited to, a description of the auction item, a category of the auction item, current bid price, a required next bid price, a bid period, a current bid time, and/or a user name associated with a current and/or winning bid. During operation, upon receiving a request from a user computing device 14, the system controller 32 retrieves information associated with each auction item 66 from the auction program 64 for display on the user computing device 14. For example, in one embodiment, the system controller 32 receives a request from a user computing device 14 to display available auction items 66. The system controller 32 transmits a request to the auction server 36 to receive a list of available auction items 66 for display on the user computing device 14. In addition, the system controller 32 receives a signal indicative of a user bid request from a user computing device 14 and transmits the bid request to the auction server 36 for use in updating the bid information associated with corresponding auction item 66.

In the illustrated embodiment, the auction server 36 conducts an on-line “penny auction”, wherein a user may place a bid on a auction item 66 using bid units to increase the total bid price by the value of the bid unit. For example, in one embodiment, each bid unit includes a purchase value and a bidding value. The purchase value is associated with the purchase of the bid unit and is indicative of an amount of money needed to purchase the bid unit. The bidding value is associated with a bid on an auction item. In one embodiment, the bid unit purchase value may be equal to the bid unit bidding value. Alternatively, the bid unit purchase value may be less than, or greater than, the bidding unit value.

For example, in the illustrated embodiment, the bid unit includes a bid purchase value equal to $1 and a bidding value equal to $0.01. During the penny auction, a user may purchase a bid unit for $1, and place a bid on an auction item using the purchased bid unit to increase the total bid amount associated with the auction item by $0.01. For example, if the current bid total amount of an auction item is $100 and the user places a bid on the auction item, the total bid amount for the auction item is increased to $100.01.

In addition, for each auction item 66 available for bid, the auction server 36 determines a bid period, e.g. a period of time in which bids for the auction item 66 will be accepted, such that the auction server 36 will accept bids submitted by user during the bid period, and awards the auction item 66 to the last bid received at the end of the bid period. In one embodiment, the auction server 36 may establish a final bid period associated with an auction item 66. If a bid is received within the final bid period, the auction server 36 may increase the bid period by an additional predetermined period of time to enable additional bids to be received. For example, in one embodiment, the bid period for an auction item may be 2 hours and the final bid period may be the last 20 seconds of the bid period. If a bid is received within the last 20 seconds, the auction server 36 increases the bid period by an additional 20 seconds. If the auction server 36 does not receive any bids within the final bid period, the bidding for the associated auction item 66 is concluded, and the auction item 66 is made available to the final bidder for purchase at the final bid total. By extending the bid period, the excitement of the auction participants is enhanced and the amount of bids purchased and used is increased.

The financial account server 40 includes financial account information associated with each user profile account. More specifically, the financial server 40 includes a financial account, a bid account, and a sweepstakes account that are associated with each user profile account. The financial account includes data that is indicative of financial information associated with a user profile. The financial information may include, but is limited to, available monetary funds for use in purchasing bid units, an available account balance, and/or any suitable financial information that enables the system 10 to function as described herein. The bid account includes information associated with each bid requested by the user including, but not limited to, a list of auction items bid on by the user, an amount of bid units available for use in an auction, a list of active auction bids, a list of winning bid items, and/or any suitable bid information that enables the system 10 to function as described herein. The sweepstakes account includes data that is indicative of a number of sweepstakes entries and/or a number of sweepstakes awards associated with the corresponding user profile. In addition, the sweepstakes account may include a list of sweepstakes awards provided to the user for use in redeeming the sweepstakes award at an associated casino property, retail or commercial enterprise.

During operation, the system controller 32 receives a user selection indicative of a bid request from a user computing device 14 including an auction item 66 associated with the bid request. The system controller 32 sends a verification message to the financial server 40 including a unique user identifier and an amount of bids associated with the bid request. The financial server 40 identifies the bid account associated with the unique user identifier and determines if sufficient bid units are available in the user bid account as a function of the bid request. If the financial server 40 determines sufficient bid units are available in the user bid account, the financial server 40 sends a verification message to the system controller 32 and deducts a corresponding amount of bid units from the user bid account. If the financial server 40 determines that the user bid account does not include a sufficient amount of bid units, the system controller 32 displays a message on the user computing device 14 requesting the user to purchase additional bid units corresponding to the bid request. In addition, the system controller 32 may display an amount of funds in the financial account that are available for use in purchasing additional bid units and/or display a number of sweepstakes entries and/or sweepstakes awards in the sweepstakes account that are available to be redeemed for additional bid units.

The sweepstakes server 38 includes a sweepstakes program 68 for conducting a sweepstakes and includes a plurality of sweepstakes entries and a plurality of sweepstakes awards associated with the entries. Each sweepstakes entry includes a unique sweepstakes identifier. In the illustrated embodiment, the sweepstakes program 68 uses a finite pool math model to award cash prizes to sweepstakes entrants who have winning entries. In one embodiment, the sweepstakes program 68 includes a predetermined number of sweepstakes entries, with each sweepstakes entry associated with a sweepstakes award. Each sweepstakes award may include, but is not limited to, a cash prize, a store credit prize, a merchandise prize, a monetary award, no award, goods, services, gaming credits for use at a casino-type gaming establishment, prizes, e.g., meals, show tickets, etc. . . . , as well as bid packages, bid units, and/or any suitable award. In one embodiment, the sweepstakes awards may include additional sweepstakes entries, cash awards for use in purchasing addition bid units and/or purchasing auction items, gaming credits for use in casino-type games at an associated gaming establishment, e.g. a casino, and/or casino service credits for use in purchasing services offered at the casino. In addition, the sweepstakes program 68 may also includes various levels of awards such as, for example, a top level or “grand” prize, and a number of other prize levels, and/or a small number of grand prizes and a larger number of prizes at one or more lower prize levels.

In the illustrated embodiment, the sweepstakes server 38 distributes one or more sweepstakes entries to a user, determines a sweepstakes award associated with each distributed sweepstakes entries, and assigns each sweepstakes award to a corresponding user profile account. The RNG 50 generates and outputs random numbers to the sweepstakes server 38 to determine an outcome of the sweepstakes entries. For example, the sweepstakes server 38 uses the RNG 50 to randomly select a plurality of sweepstakes entries, and to associate an sweepstakes award with each selected sweepstakes entry. In one embodiment, the sweepstakes server 38 uses the RNG 50 to randomly select a predetermined number of sweepstakes entries to be provided to a user. In another embodiment, the sweepstakes server 38 uses the RNG 50 to assign sweepstakes entries from a pool of predetermined sweepstakes entries, with each entry being associated with a result in the sweepstakes game.

The sweepstakes server 38 also includes a game program 70 for use in displaying a sweepstakes award to an associated user. More specifically, the game program 70 is configured to operate in an instant reveal mode and a game mode based on a user's selection. In the instant reveal mode, the game program 70 determines the sweepstakes awards associated with each sweepstakes entry distributed to the player, and reveals the sweepstakes award in an instant reveal game 72 (shown in FIG. 8) that displays a total sweepstakes award received by the user from each of the sweepstakes entries. In game mode, the game program 70 displays a list 74 of simulated casino-type games 62 (shown in FIG. 5) from the game list 60 and enables the user to select one or more simulated casino-type games 62 for use in displaying each sweepstakes award associated with the user's sweepstakes entries.

During operation in game mode, the game program 70 determines a number of sweepstakes entries to reveal based on a user selection, and generates a corresponding number of gaming credits. The game program 70 allows the user to reveal one or more sweepstakes entries in the form of the outcome of the selected simulated casino-type game 62. The game program 70 generates an outcome 76 of the simulated casino-type game 62 and displays the generated outcome 76 to the user. The game outcome 76 is indicative of the sweepstakes award associated with the sweepstakes entries selected to be revealed by the user. For example, in one embodiment, the game program 70 displays a simulated video slot game 78 (shown in FIG. 7) based on a user selection. In the illustrated embodiment, the simulated video slot game 78 includes a plurality of slot reels 80, each slot reel 80 displaying a plurality of game symbols 82. The simulated video slot game 78 also includes a plurality of pay lines 84 to indicate, to the user, a combination of game symbols 82. The simulated video slot game 78 is generally played in a conventional manner. The user may increase or decrease the number of sweepstakes entries to reveal by selecting one or more pay lines 84. The game program 70 determines the sweepstakes award associated with the quantity of sweepstakes entries revealed and generates a game outcome associated with the sweepstakes award. The game program 70 spins the reels, and selectively stops the reels to display a predetermined pattern of game symbols 82 that is determined as a function of the selected pay line, a pay table, and the sweepstakes awards associated with the selected sweepstakes entries.

In another embodiment, the game program 70 displays a simulated video blackjack game 86 (shown in FIG. 6) for use in revealing the sweepstakes award to the user. The simulated blackjack game 86 is conducted in the convention manner. The game program 70 allows the user to wager one or more credits indicative of sweepstakes entries, distributes a hand of playing cards to the user and a hand of playing cards to the “dealer”. The outcome of the simulated blackjack game 86 is determined as a function of the sweepstakes awards associated with the requested quantity of sweepstakes entries, and the game program 70 provides the player an award based on the predetermined outcome. Many variations to the above described general actuation of simulated casino-type games fall within the scope of the present invention.

In the illustrated embodiment, the workstation 54 includes a display and user input device to enable an administrative user to access the server system 12 to transmit data indicative of the auction events and/or auction items to the database server 42. This enables an administrative user to periodically update the auction items associated with auction events, available auction items, and/or any suitable data and information that enables the system 10 to function as described herein.

FIG. 2 is a flowchart of a method 200 that may be used with the system 10 for allowing a user to participate in an online auction via a user computing device 14. Portions of the method 200 may be performed by any one of, or any combination of, the server system 12 and/or the user computing devices 1. FIGS. 3-8 are entertaining graphical displays for amusement purposes that may be used with method 200. In the illustrated embodiment, entertaining graphical displays for amusement purposes are presented by the user computing device 14 via the display device 26 (shown in FIG. 1) and may receive input (e.g., selections and/or entries) via the user input device 28 (shown in FIG. 1). For example, in one embodiment, a selection may be received via user input device 28 of the user computing device 14 and may be transmitted by the user computing device 14 to the server system 12 via the network 16.

In the illustrated embodiment, the method 200 includes the step of receiving 202 a request to display information including an auction event from a user computing device 14. In one embodiment, the user may submit the request by accessing a website via web server 34. In another embodiment, the user may access a mobile website via the cellular network 18. In addition, in one embodiment, the method 200 may include receiving a unique user identifier to validate the request to display the auction event. More specifically, the system controller 32 may display a login screen (not shown) on the user computing device 14 to request the unique user identifier such as, for example requesting a username and/or password. The system controller 32 receives the unique user identifier and transmits a validation request including the user credentials to the database server 42. The database server 42 compares the received unique user identifier with the collection of unique user identifier contained in the user profile program 56 to validate the unique user identifier and responsively sends a validation message to the system controller 32 if the received unique user identifier is included in the user profile program 56. Upon receiving the validation message from the database server 42 the system controller 32 displays a listing of auction items. In addition, in one embodiment, if the received user identifier is not included in the user profile program 56, the system controller 32 may prompt the user to establish a user account and/or display the auction event without requiring the user to establish a user account and/or verify a user account.

In the illustrated embodiment, the method 200 includes the step of retrieving 204 an auction event list including a plurality of auction items 66 and displaying the list of auction items on the user computing device 14. In one embodiment, the system controller 32 transmits a user profile request to the database server 42 including the unique user identifier and retrieves the corresponding user profile account including a collection of user-defined categories indicative of preferred auction items from the database server 42. The system controller 32 determines the user profile account associated with the unique identifier, selects a plurality of auction items from the auction event list based on the user-defined categories, and displays the selected auction items on the user computing device 14.

In the illustrated embodiment, the system controller 32 displays a plurality of user selection areas 100 within the graphical interface 11 that correspond to specific operations that may be initiated by the user. For example, in the illustrated embodiment, the system controller 32 displays a plurality of auction items 66 and an associated “BID” selection area 102. Each of the areas may receive a user selection input via the user input device 28. In one embodiment, upon receiving a user selection input associated with the “BID” selection area 102, the system controller 32 increments the total bid amount associated with corresponding auction item by the bid unit bidding value, and deducts a bid unit from the total number of bid units associated with the user profile account.

In the illustrated embodiment, the method 200 includes the step of receiving 206 a first bid unit purchase request from a user and responsively generating at least one initial bid unit for use in bidding on one or more auction items 66 displayed in the auction. The method 200 also includes the steps of distributing 208 at least one sweepstakes entry into a sweepstakes event to the user in response to the received purchase request and providing 210 a sweepstakes award to the user determined as a function of the at least one sweepstakes entry. The method 200 also includes the step of allowing 212 the user to purchase at least one addition bid unit with at least a portion of the sweepstakes award.

In the illustrated embodiment, the method includes the steps of receiving 214 a second bid unit purchase request from the user to purchase at least one additional bid unit, responsively generating at least one additional bid unit for bidding on the one or more auction items, and distributing 216 one or more sweepstakes entries in response to the second bid unit purchase request. In one embodiment, the system controller 32 may distribute a number of sweepstakes entries to the user as a function of a number of initial bid units purchased by the user. For example, the system controller 32 may distribute a first number of sweepstakes entries to the user as a function of the first bid unit purchase request and distribute a second number of sweepstakes entries to the user as a function of the second bid unit purchase request. In one embodiment, the second number of sweepstakes entries is different than the first number of sweepstakes entries. In another embodiment, the second number of sweepstakes entries may be less than, greater than, or equal to the first number of sweepstakes entries.

In the illustrated embodiment, the method includes the steps of receiving 218 a bid associated with an auction item and responsively increasing 220 a bid amount associated with the auction item by the corresponding bid unit bidding value. In one embodiment, the system controller 32 may also establish a bid period associated with the auction item, determine a final bid received during the bid period, and award the auction item a user associated with the final bid. In another embodiment, the system controller 32 may establish a final bid period associated with the auction item, receive one or more bids associated with the auction item, determine if a bid is received within the final bid period, and responsively increase the bid period a predefined amount of time if a bid is received within the final bid period.

In the illustrated embodiment, the method 200 also includes the step of receiving 222 a request to reveal the sweepstakes award associated with the at least one sweepstakes entry, responsively determining the sweepstakes award, and allow 224 the user to select one of an instant reveal mode wherein the sweepstakes award is displayed to the user and a game mode wherein at least one game is displayed to the user, the outcome of the at least one game being indicative of the sweepstakes award. Upon receiving a request to reveal the sweepstakes award, the system controller 32 displays a graphical interface 11 (shown in FIG. 4) that includes an “instant reveal” selection area and a “fun reveal” selection area. The “instant reveal” selection is associated with the instant reveal mode and the “fun reveal” selection is associated with the game mode. In the illustrated embodiment, upon selection of the “instant reveal” selection area, the system controller 32 operates the game program 70 in the instant reveal mode, and upon selection of the “fun reveal” selection area, the system controller 32 operates the game program 70 in the game mode.

In the illustrated, the method 200 includes the steps of receiving 226 a request to reveal the sweepstakes award with the simulated game mode and responsively displaying a plurality of user-selectable simulated games 62, receiving 228 a game request indicative of one simulated game of the plurality of simulated games, and responsively displaying a simulated game outcome associated with the selected simulated game that is indicative of the sweepstakes award. In one embodiment, the method 200 may include the steps of allowing the user to allocate a portion of the sweepstakes entries over a plurality of games, displaying a first game (shown in FIG. 6) based on a received first game request, receiving a first sweepstakes entry allocation from the plurality of sweepstakes entries associated with the first game, and, responsively displaying an outcome of the first game that is indicative of a first portion of the sweepstakes award associated with the first sweepstakes entry allocation. In addition, the method 200 may include the steps of displaying a second game based on a received second game request, receiving a second sweepstakes entry allocation, and responsively displaying an outcome of the second game that is indicative of a second portion of the sweepstakes award associated with the second sweepstakes entry allocation.

The above-described systems and methods overcome at least some disadvantages of known auction systems by enabling a user to purchase one or more bid packets for use in an auction, providing the user with entries into a sweepstakes based on an amount of purchased bid packets, and enabling the user to reveal the results of the sweepstakes entries via one or more simulated casino-type games. In addition, the system and methods allow the user to purchase at least one additional bid unit with at least a portion of the sweepstakes award. By providing a plurality of sweepstakes entries to the user based on a purchase of bid packets for use in an auction and allowing the user to use the sweepstakes award to purchase additional bid packets, the amount of time a user spends bidding on auction items is increased, thus increasing the amount of bids received for the auction items and increasing the amount of revenue received from the auction. As discussed above, the sweepstakes awards may be used to purchase goods and services, redeemed as cash or as some other benefit, or donated to charity.

Exemplary embodiments of a system and method of allowing a user to reveal sweepstakes entries via a mobile computing device are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other wagering applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A method of conducting an auction, including the steps of:
receiving a first bid unit purchase request from a user and responsively generating at least one initial bid unit for bidding on one or more auction items displayed in the auction;
distributing at least one sweepstakes entry into a sweepstakes event to the user in response to the received purchase request;
providing a sweepstakes award to the user as a function of the at least one sweepstakes entry; and,
allowing the user to purchase at least one additional bid unit with at least a portion of the sweepstakes award.

2. A method in accordance with claim 1, including the step of distributing a number of sweepstakes entries to the user as a function of a number of initial bid units purchased by the user.

3. A method in accordance with claim 1, including the steps of
receiving a second bid unit purchase request from the user to purchase at least one additional bid unit; and
responsively generating at least one additional bid unit for bidding on the one or more auction items.

4. A method in accordance with claim 3, including the steps of:
distributing a first number of sweepstakes entries to the user as a function of the first bid unit purchase request; and
distributing a second number of sweepstakes entries to the user as a function of the second bid unit purchase request.

5. A method in accordance with claim 4, wherein the second number of sweepstakes entries is different than the first number of sweepstakes entries.

6. A method in accordance with claim 1, wherein each bid unit includes a purchase value associated with a purchase of the bid unit and a bidding value associated with a bid on an auction item.

7. A method in accordance with claim 6, wherein the bid unit purchase value is different than the bid unit bidding value.

8. A method in accordance with claim 6, including the steps of:
receiving a bid associated with an auction item, the bid including a corresponding bid unit having a bidding value; and
responsively increasing a bid amount associated with the auction item by the corresponding bid unit bidding value.

9. A method in accordance with claim 8, including the steps of:
establishing a bid period associated with the auction item, the bid period being defined as a period of time within which bids associated with auction item may be received;
determining a final bid received during the bid period; and
awarding the auction item a user associated with the final bid for the payment thereof.

10. A method in accordance with claim 9, including the steps of:
establishing a final bid period associated with the auction item, the final bid period being associated with a portion of the bid period;
receiving one or more bids associated with the auction item;
determining if a bid is received within the final bid period; and
responsively increasing the bid period a predefined amount of time if a bid is received within the final bid period.

11. A method in accordance with claim 1, including the steps of:
receiving a request to reveal the sweepstakes award associated with the at least one sweepstakes entry and responsively determining the sweepstakes award; and,
allowing the user to select one of an instant reveal mode wherein the sweepstakes award is displayed to the user and a game mode wherein at least one game is displayed to the user, the outcome of the at least one game being indicative of the sweepstakes award.

12. A method in accordance with claim 11, including the steps of:
receiving a request to reveal the sweepstakes award with the game mode and responsively displaying a plurality of user-selectable games;
receiving a game request indicative of one game of the plurality of games; and
responsively displaying a game outcome associated with the selected game, the game outcome being indicative of the sweepstakes award.

13. A method in accordance with claim 12, wherein the user received a plurality of sweepstakes entries, the method includes the steps of:
allowing the user to allocate a portion of the sweepstakes entries over a plurality of games;
displaying a first game based on a received first game request;
receiving a first sweepstakes entry allocation from the plurality of sweepstakes entries associated with the first game; and,
responsively displaying an outcome of the first game that is indicative of a first portion of the sweepstakes award associated with the first sweepstakes entry allocation.

14. A method in accordance with claim 13, including the steps of:
displaying a second game based on a received second game request;
receiving a second sweepstakes entry allocation; and
responsively displaying an outcome of the second game that is indicative of a second portion of the sweepstakes award associated with the second sweepstakes entry allocation.

15. A system for allowing a user to participate in an auction via a user computing device, comprising:
a plurality of user computing devices, each user computing device including a user input device for accepting a user's selection input and a display device; and
a system controller coupled to each user computing device of the plurality of user computing devices, the system controller for receiving, from at least one of the user computing devices, a request to display information associated with the auction, retrieving, from a database, a plurality of auction items included in the auction, and displaying the plurality of auction items on the corresponding user computing device, the system controller for receiving a first bid unit purchase request from a user, responsively generating at least one initial bid unit for bidding on one or more auction items displayed in the auction, distributing at least one sweepstakes entry into a sweepstakes event to the user in response to the received purchase request, providing a sweepstakes award to the user as a function of the at least one sweepstakes entry, and allowing the user to purchase at least one addition bid unit with at least a portion of the sweepstakes award.

16. A system in accordance with claim 15, the system controller for distributing a number of sweepstakes entries to the user as a function of a number of initial bid units purchased by the user.

17. A system in accordance with claim 15, the system controller for receiving a second bid unit purchase request from the user to purchase at least one additional bid unit and responsively generating at least one additional bid unit for bidding on the one or more auction items.

18. A system in accordance with claim 17, the system controller for distributing a first number of sweepstakes entries to the user as a function of the first bid unit purchase request and distributing a second number of sweepstakes entries to the user as a function of the second bid unit purchase request.

19. A system in accordance with claim 18, wherein the second number of sweepstakes entries is different than the first number of sweepstakes entries.

20. A system in accordance with claim 15, wherein each bid unit includes a purchase value associated with a purchase of the bid unit and a bidding value associated with a bid on an auction item.

21. A system in accordance with claim 20, wherein the bid unit purchase value is different than the bid unit bidding value.

22. A system in accordance with claim 20, the system controller for receiving a bid associated with an auction item, the bid including a corresponding bid unit having a bidding value and responsively increasing a bid amount associated with the auction item by the corresponding bid unit bidding value.

23. A system in accordance with claim 22, the system controller for establishing a bid period associated with the auction item, the bid period being defined as a period of time within which bids associated with auction item may be received, determining a final bid received during the bid period, and awarding the auction item a user associated with the final bid.

24. A system in accordance with claim 23, the system controller for establishing a final bid period associated with the auction item, the final bid period being associated with a portion of the bid period, receiving one or more bids associated with the auction item, determining if a bid is received within the final bid period, and responsively increasing the bid period a predefined amount of time if a bid is received within the final bid period.

25. A system in accordance with claim 15, the system controller for receiving a request to reveal the sweepstakes award associated with the at least one sweepstakes entry and responsively determining the sweepstakes award and allowing the user to select one of an instant reveal mode wherein the sweepstakes award is displayed to the user and a simulated game mode wherein at least one game is displayed to the user, the outcome of the at least one game being indicative of the sweepstakes award.

26. A system in accordance with claim 25, the system controller for receiving a request to reveal the sweepstakes award with the simulated game mode and responsively displaying a plurality of user-selectable simulated games, and for receiving a game request indicative of one game of the plurality of games and responsively displaying a game outcome associated with the selected game, the game outcome being indicative of the sweepstakes award.

27. A system in accordance with claim 26, wherein the user received a plurality of sweepstakes entries, the system controller for allowing the user to allocate a portion of the sweepstakes entries over a plurality of simulated games, displaying a first game based on a received first game request, receiving a first sweepstakes entry allocation from the plurality of sweepstakes entries associated with the first game, and responsively displaying an outcome of the first game that is indicative of a first portion of the sweepstakes award associated with the first sweepstakes entry allocation.

28. A system in accordance with claim 27, the system controller for displaying a second game based on a received second game request, receiving a second sweepstakes entry allocation, and responsively displaying an outcome of the second game that is indicative of a second portion of the sweepstakes award associated with the second sweepstakes entry allocation.

29. One or more non-transitory computer-readable storage media, having computer-executable instructions embodied thereon, wherein when executed by at least one processor, the computer-executable instructions cause the processor to:
receive a request from a user to display information associated with an auction;
retrieve, from a database, an auction list including a plurality of auction items and display the plurality of auction items on a user computing device;
receive a first bid unit purchase request from the user and responsively generate at least one initial bid unit for bidding on one or more auction items displayed in the auction;
distribute at least one sweepstakes entry into a sweepstakes event to the user in response to the received purchase request;
provide a sweepstakes award to the user as a function of the at least one sweepstakes entry; and,
allow the user to purchase at least one addition bid unit with at least a portion of the sweepstakes award.

30. The one or more computer-readable storage media according to claim 29, wherein when executed by at least one processor, the computer-executable instructions cause the processor to distribute a number of sweepstakes entries to the user as a function of a number of initial bid units purchased by the user.

31. The one or more computer-readable storage media according to claim 29, wherein when executed by at least one processor, the computer-executable instructions cause the processor to:
receive a second bid unit purchase request from the user to purchase at least one additional bid unit; and
responsively generate at least one additional bid unit for bidding on the one or more auction items.

32. The one or more computer-readable storage media according to claim 31, wherein when executed by at least one processor, the computer-executable instructions cause the processor to:
distribute a first number of sweepstakes entries to the user as a function of the first bid unit purchase request; and
distribute a second number of sweepstakes entries to the user as a function of the second bid unit purchase request.

33. The one or more computer-readable storage media according to claim 32, wherein the second number of sweepstakes entries is different than the first number of sweepstakes entries.

34. The one or more computer-readable storage media according to claim 29, wherein each bid unit includes a purchase value associated with a purchase of the bid unit and a bidding value associated with a bid on an auction item.

35. The one or more computer-readable storage media according to claim 34, wherein the bid unit purchase value is different than the bid unit bidding value.

36. The one or more computer-readable storage media according to claim 34, wherein when executed by at least one processor, the computer-executable instructions cause the processor to:
receive a bid associated with an auction item, the bid including a corresponding bid unit having a bidding value; and
responsively increase a bid amount associated with the auction item by the corresponding bid unit bidding value.

37. The one or more computer-readable storage media according to claim 36, wherein when executed by at least one processor, the computer-executable instructions cause the processor to:
establish a bid period associated with the auction item, the bid period being defined as a period of time within which bids associated with auction item may be received;
determine a final bid received during the bid period; and
award the auction item a user associated with the final bid to be purchased thereof.

38. The one or more computer-readable storage media according to claim 37, wherein when executed by at least one processor, the computer-executable instructions cause the processor to:
establish a final bid period associated with the auction item, the final bid period being associated with a portion of the bid period;
receive one or more bids associated with the auction item;
determine if a bid is received within the final bid period; and
responsively increase the bid period a predefined amount of time if a bid is received within the final bid period.

39. The one or more computer-readable storage media according to claim 29, wherein when executed by at least one processor, the computer-executable instructions cause the processor to:
receive a request to reveal the sweepstakes award associated with the at least one sweepstakes entry and responsively determining the sweepstakes award; and,
allow the user to select one of an instant reveal mode wherein the sweepstakes award is displayed to the user and a game mode wherein at least one game is displayed to the user, the outcome of the at least one game being indicative of the sweepstakes award.

40. The one or more computer-readable storage media according to claim 39, wherein when executed by at least one processor, the computer-executable instructions cause the processor to:
receive a request to reveal the sweepstakes award with the game mode and responsively displaying a plurality of user-selectable games;
receive a game request indicative of one game of the plurality of games; and
responsively display a game outcome associated with the selected game, the game outcome being indicative of the sweepstakes award.

41. The one or more computer-readable storage media according to claim 40, wherein the user received a plurality of sweepstakes entries, when executed by at least one processor, the computer-executable instructions cause the processor to:
display a first game based on a received first game request;
receive a first sweepstakes entry allocation from the plurality of sweepstakes entries associated with the first game; and,
responsively display an outcome of the first game that is indicative of a first portion of the sweepstakes award associated with the first sweepstakes entry allocation.

42. The one or more computer-readable storage media according to claim 41, wherein when executed by at least one processor, the computer-executable instructions cause the processor to:
display a second game based on a received second game request;
receive a second sweepstakes entry allocation; and
responsively display an outcome of the second game that is indicative of a second portion of the sweepstakes award associated with the second sweepstakes entry allocation.
